(19) United States
(12) Patent Application Publication
(10) Pub. No.: US 2013/0235399 A1
(43) Pub. Date: Sep. 12, 2013

(54) SYSTEMS AND METHODS FOR EMPLOYING DECLARATIVE PROGRAMMING TO OPTIMIZE DYNAMIC OPERATIONS IN COMPLEX IMAGE FORMING AND MEDIA HANDLING DEVICES

(71) Applicant: Paul Roberts CONLON, South Bristol, NY (US)

(72) Inventor: Paul Roberts CONLON, South Bristol, NY (US)

(73) Assignee: XEROX CORPORATION, Norwalk, CT (US)

(21) Appl. No.: 13/417,101

(22) Filed: Mar. 9, 2012

(51) Int. Cl. G06K 15/16

(52) U.S. Cl. 358/1.12

(57) ABSTRACT

A system and method are provided to find feasible and correct image forming flow paths for complex image forming systems by categorizing all possible orientations, in two dimensions for imaging operations, and in three dimensions for media handling operations, according to mathematical representations that can then be manipulated by matrix algebra. A given input orientation is provided as an input logic state and a desired output orientation is provided as an output logic state, each being defined according to a mathematical representation. A declarative programming scheme is applied that uses matrix algebra to manipulate the input mathematical representation in order to determine feasible, optimized, and possibly constrained operations to achieve the output mathematical representation. This approach abandons the time-consuming, haphazard, and fragile conventional approach of describing orientations descriptively, and inconsistently and then applying a trial and error method to arrive at a desired output state.

This application is related to U.S. Patent Application Publication Nos. 2010/0156890, filed Dec. 18, 2008; 2010/0157325, filed Dec. 11, 2009; 2010/0158411, filed Dec. 18, 2008; 2010/0157324, filed Dec. 11, 2009; 2010/0156937, filed Dec. 18, 2008; 2010/0157323, filed Dec. 11, 2009; 2010/0156940, filed Dec. 19, 2008; 2010/0156938, filed Dec. 11, 2009; 2010/0157319, filed Dec. 11, 2009; 2010/0157320, filed Dec. 11, 2009; 2010/0157322, filed Dec. 11, 2009; and 2010/0157321, filed Dec. 11, 2009, each of which is entitled “Method And System For Utilizing Transformation Matrices To Process Rasterized Image Data.” This application is also related to U.S. Patent Application Publication Nos. 2011/0109918, filed Nov. 9, 2009, entitled “Controlling Placement And Minimizing Distortion Of Images In An Imaging Device,” and 2011/0109919, filed Nov. 9, 2009, entitled “Architecture For Controlling Placement And Minimizing Distortion Of Images,” and U.S. patent application Ser. Nos. 13/155,756, filed Jun. 8, 2011, entitled “Frame-Based Coordinate Space Transformations Of Graphical Image Data In An Image Processing System,” and 13/155,723, filed Jun. 8, 2011, entitled “Image Operations Using Frame-Based Coordinate Space Transformations Of Image Data In A Digital Imaging System.” These applications are co-owned by the Assignee of this application. The disclosures of the related applications are hereby incorporated by reference herein in their entirety.

### BACKGROUND

1. Field of Disclosed Subject Matter

This disclosure relates to systems and methods for implementing a declarative programming scheme to optimize dynamic operations for image forming and media handling in complex image forming and media handling devices.

2. Related Art

Complex image forming systems combine image forming processes and associated media handling and finishing processes. In the field of image forming devices, very complex production-type systems for advanced image forming, and the associated media handling, have been, and continue to be, developed and deployed. These complex image forming systems may include, for example, multiple stages of image processors with a plurality of feeder devices and a number of finishing devices. Image receiving media flow through these complex image forming (and media handling) systems via multiple paths in an intricate and variable manner according to a particular image forming operation requested by a user and carried out by the complex image forming system.

An ordering of the multiple devices in these complex image forming systems can be changed. Individual devices are reordered or replaced in a particular complex image forming system for myriad reasons. As a result, imaging and image receiving media flow paths through the complex image forming systems can be changed and can often become confused. In many instances, a result of this confusion is that image forming errors and/or finishing errors occur. Images can be printed upside down, on a wrong side of the paper, or not in a pre-printed form as a user intended. Staples can be placed in the wrong corner. Folds can be improperly applied. Image shifts can be performed in a manner that is wholly detached from an anticipated orientation of the image receiving medium resulting in an improper image shift. These errors, individually or collectively, produce outputs from the complex image forming systems that are not the finished product that the user expects, leading to customer dissatisfaction.

What is not clear to the common user of the complex image forming system, but is common knowledge to those of skill in the art, is that any particular imaging task or job requested by a user includes multiple individual imaging operations each according to a specified orientation. An exemplary and non-exhaustive list of individual imaging operations includes scaling or sizing, translation or image shift, mirroring or reflecting, and rotation of images in two dimensions and of image receiving media in three dimensions. Each individual image processing and/or media handling component that is included as a portion of a particular complex imaging forming system may carry out individual tasks with a particular flow of the images and the image receiving media through that individual component.

Difficulties often arise in that an order of individual image forming operations is non-commutative. As such, certain manipulation of the order of the operations, including adding additional steps, may need to be undertaken to produce a repeatable output based on an ordering of the operations. This manipulation can make the outcome of the operations repeatable. Stated differently, any change in the order of these operations as a set of transformations will typically result in a different output unless modified in some manner that may or may not be available to the system designer and/or programmer. An additional difficulty is that individual orientations of images and image receiving media at any particular point in the image forming process in the complex image forming system are difficult to track externally.

The above difficulties can be compounded based on conventional approaches to programming of the individual devices and specifically characterizing orientations of images and image receiving media within that programming. The characterizations of orientations of images and image receiving media in the programming of conventional systems are generally viewed, and therefore provided, in a descriptive or narrative form. When programs are written in, for example, C code or C++, rather than characterizing the image orientations according to any common and manipulable mathematical framework, descriptive terms (or enumerations) are employed. These may include, for example, descriptors such as “faceup” or “facedown,” and “inboard” or “outboard.” With regard to raster orientations, similar descriptive terms are used such as, for example, “slow scan” and “fast scan.” These descriptive terms may be generally understood and tracked in the context of a single simple image forming device. Interpretation of these descriptive terms, however, across different devices tends to be inconsistent and therefore haphazard. The inconsistencies manifest themselves in two general ways.

First, the descriptive terms are often not consistent across devices and manufacturers as variations in the descriptive terms may be employed by individual manufacturers, or applied to individual devices leading to difficulties in interpretation between different devices. In other words, different words may be used to describe the same or similar operations, thereby leading to interpretational difficulties.

Second, even if consistent descriptive terms are used, the points of origin for the operations and directions in which the operations are undertaken may differ between devices and between manufacturers. Many times devices or fleets of devices, even when produced by a same manufacturer, use different origin points and/or coordinate references as a basis by which to interpret the descriptive labels for the orientations of images and image receiving media in individual devices. Without a common frame of reference, the descriptive terms are left to the interpretation of the individual devices according to individual device frames of reference as individual devices carry out electronic image scanning and processing functions as well as mechanical image media handling and finishing functions.

Overall imaging operations such as device specific scaling, translation, reflection, rotation and edge erase are individually undertaken relative to a particular coordinate space referenced to a particular origin for a particular device that may be completely different from another coordinate space referenced to another origin for another device. The coordinate spaces and origins by which a particular image forming device or component references image and image receiving media orientations typically varies from device to device.

As an example, scanners have varying origins and scanning directions such that saved scanned images may be inconsistent across different scanning devices. Print and Copy/Scan operations suffer similar shortfalls. Scaling, as another example, is conducted relative to a particular origin or reference point and in a particular direction. Across differing devices, a user's request to scale down or scale up (reduce/enlarge) a particular image may result in different image registration or clipping (cropping) regions according to different device origins and orientations, thereby frustrating the user's expectations.

Another commonly understood example is that individual devices rotate and flip images and image receiving media in different directions, clockwise or counter clockwise for planar rotations, and with respect to different corners or edges for image receiving media flipping. In the context of ordered operations, the direction in which an image, or an image receiving medium is rotated, and the edges about which the image receiving medium is flipped, must be specified because rotating an image in an opposite direction, or flipping an image receiving medium about a different edge, will result in different image registration for the image on the image receiving medium.

Origins, directions of execution and orders of particular internal operations are often fixed for each individual image forming device or component and separately for each individual media handling device or component, including those that together make up complex image forming systems. The user cannot generally select a different origin, i.e., a particular corner, the center, or an arbitrary point in the imaging frame, or a different order of operations for a particular device. The user cannot generally specify a different direction of rotation, or a different edge about which image media is to be flipped from, for example, a faceup to a facedown orientation, when, for example, a particular image output is not according to a user's desires. Also, it is difficult to even specify both orientations and operations, i.e., rotation and/or reflection because the current approaches are so disconnected. This difficulty is then compounded when one considers that image paths are two-dimensional and image receiving medium paths are three-dimensional. The operations and orientations are disconnected within each of these paths, these disconnects compounding across the image and image media handling domains.

Significant difficulties result from the compounding of all of the above issues. Image receiving media flow through complex image forming systems according to orientations in three dimensions with the variable image orientations and variable raster device orientations, each according to its own reference and orientation framework, i.e., not according to any common framework. The system designer and/or programmer must piece together individual components of the complex image forming system, each with its own specified order of operations and origins and orientations, initially according to a complex iterative trial and error process in order to provide a complex image forming system in which a user obtains an output from his or her requested imaging job according to the user's desires. For example, if a sheet of image receiving media goes through a complex system, and at the output of the complex system the image is upside down, the system designer and/or programmer may add a rotation to account for this discrepancy. This iterative trial and error process would be further compounded, for example, if in addition to the image being registered upside down on the image receiving media, the image was also printed on the wrong face of the image receiving media.

Once this complex iterative trial and error method is completed for a particular complex system, the system designer and/or programmer is not finished. The schemes that result from the trial and error process remain very fragile. Even slight changes in operations can cripple the correctness of the solution. When a particular component in the complex image forming system is replaced, the process must be repeated, often again in a trial and error manner, in order to obtain a repeatable outcome that is according to the user's desires. In other words, any slight change in configuration for the system generally renders all of a previous trial and error effort to determine a correct scheme a nullity. The system programmer must, in many cases, essentially start over from scratch.

Again, this is because a particular orientation for each of the image and the image receiving medium at any point in the image flow path through the complex system is difficult to envision according to conventional methods.

### SUMMARY OF THE DISCLOSED EMBODIMENTS

In view of the above-identified shortfalls in conventional complex image forming and media handling systems, previous research by the inventor of the subject matter of this disclosure has defined a common framework for transformation of image origins and coordinate spaces across multiple devices. See, e.g., co-owned U.S. patent application Ser. Nos. 13/155,756, entitled “Frame-Based Coordinate Space Transformations Of Graphical Image Data In An Image Processing System” and 13/155,723, entitled “Image Operations Using Frame-Based Coordinate Space Transformations Of Image Data In A Digital Imaging System.”

In a three-dimensional system, there is a set of forty-eight definable coordinate systems. (Note that imaging in printing applications typically occurs in a two-dimensional coordinate system. In the two-dimensional system, there is a set of eight definable coordinate systems that may simply be considered a subset of the set of forty-eight definable three-dimensional coordinate systems in which Z is consistently set to zero. In this manner, two-dimensional imaging operations may interoperate seamlessly with three-dimensional operations performed on image receiving media). One of the forty-eight variations represents the standard Cartesian coordinate system, and the other forty-seven variations are deviations from that standard. For ease of interpretation, and to avoid confusion, this disclosure will refer to the available set of coordinate systems as “the forty-eight coordinate systems.” This set of forty-eight coordinate systems is based on the existence of six permutations of XYZ orientations that can be mapped to each of the eight corners of a cube representing the three-dimensional system. These forty-eight coordinate systems can be alternatively mathematically represented according to a corresponding set of forty-eight individual mathematical representations transformations that respectively identify each of the coordinate systems.

Examples of limited numbers of the above-described mathematical representations and associated visual representations are presented in the above-identified co-owned U.S. patent applications. FIGS. 1A and 1B illustrate an example correspondence between a visual representation of a three-dimensional coordinate system 100 and a corresponding mathematical representation 150 according to this inventor's previous work as a foundation for the disclosed systems and methods. As shown in FIG. 1A, each of the forty-eight coordinate systems may be visually represented as having an origin 110 from which orthogonal axes, X-axis 120, Y-axis 130 and Z-axis 140 emanate. The origin 110 could be anyone of the eight corners of the depicted cube. Varying combinations of the axes will emanate from each of those origins resulting in the forty-eight coordinate systems discussed above. A mathematical representation 150, in a mathematical matrix format as shown in FIG. 1B, may be assigned to each of the coordinate systems. This assignment of mathematical representations, in a mathematical matrix format, as shown, facilitates combining program operations (transformations) using matrix algebra as a processing medium for the systems and methods according to this disclosure. It should be noted that the specific mathematical representations shown in in FIG. 1B, and in the referenced documents, are only examples of the mathematical representation matrices that could be employed to define each of the forty-eight coordinate systems. Those of skill in the art of image forming systems and mathematics will recognize that a particular three-dimensional coordinate system can be represented in a number of different ways mathematically in the form of a numerical matrix.

Regardless of their construct, the corresponding set of forty-eight individual mathematical representations, when taken together, define a mathematical group. With the forty-eight coordinate systems being defined or represented mathematically, matrix algebra is applied in manipulation of the individual mathematical transformations to rotate or reflect the coordinate spaces to different ones of the forty-eight possible orientations. Each resultant orientation is a member of the mathematical group. Any series of multiple operations undertaken to a beginning orientation necessarily results in an ending orientation that is defined as one of the orientations in the group.

An advantage of finding a common definition or interpretation for the multiple coordinate systems as they are applied to image forming and media handling devices is that individual orientations of images and image receiving media in the image forming and media handling devices can be succinctly expressed and manipulated according to the common mathematical framework. Coordination can then be effected between the image receiving media flowing through a complex system of multiple devices and images being processed by the system according to raster images and visual images. Application of the mathematical framework provides a capability by which the effects of changes that are made in an order of imaging operations can be accurately predicted and evaluated, obviating the requirement for conventional complex trial and error processes in order to achieve or maintain the desired output from the system. The derived mathematical framework facilitates a level of automation and precision that was previously unavailable to system designers and/or programmers.

It would be advantageous to apply the common mathematical representation interpretation methodology described above in a manner that would assist in (1) avoiding customer dissatisfaction with the performance of complex image forming systems based on defects in imaging and finishing due to incorrect operations being applied, and (2) aiding the system developer and/or programmer in establishing a predictive relationship between an input orientation and an output orientation in order that the user can be told how to orient the image receiving media at an input of the complex image forming system in order to obtain the desired output orientation.

Exemplary embodiments according to this disclosure may apply declarative programming, defining a source state and a target state for an image formed on an image receiving medium, and allowing a processor to assess available imaging operations and respective orders of operations to most effectively achieve the target state.

Exemplary embodiments may provide a predictive capability whereby common image processing and finishing defects such as, for example, staples in a wrong corner, images being incorrectly oriented on a page, forms not filled in correctly or other myriad performance issues relating to orientation, can be avoided.

Exemplary embodiments may provide a capacity in which, when system components are changed or replaced, routine errors based on modifications in flow paths through the complex system are avoided through simple instructions to a user regarding a specific orientation of the image receiving media at an input of the complex image forming system.

Exemplary embodiments may provide for application of a previously-developed system for describing orthogonal orientations in two dimensions and/or in three dimensions to characterize the particular relationship between a source or input image receiving media orientation and a target or output image receiving media orientation. Given the source orientation and the target orientation, the disclosed systems and methods may generate a comprehensive listing of permutations representing all possible feasible (and correct) operations of rotation and reflection in three dimensions in a complex image forming system.

Exemplary embodiments may provide a filtering methodology whereby a comprehensive listing of permutations representing all possible feasible (and correct) operations of rotation and reflection in three dimensions in the complex image forming system are specifically constrained based on limitations imposed by an availability of specific operational components, and specified flow paths through those specific operational components, by which to construct the complex image forming system.

Exemplary embodiments may provide a capacity to apply weighting and/or costing factors to specified operations so that feasible operations sets may be sorted according to the applied weighting and/or costing factors.

Exemplary embodiments may include, in the software for controlling the complex image forming system, a capability to automatically determine many needed operations, thereby providing relief from conventional fragile and error-prone logic.

Exemplary embodiments may extend the tools that are available to provide visual graphics of operations, and orientations associated with those operations, which can aid in a user's or developer's understanding of the orientation flow through the system. Such tools may facilitate error diagnostics and/or improvements in design of new image paths and image receiving medium paths for complex image forming and media handling systems.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and methods for implementing declarative programming to optimize dynamic operations in complex image forming and media handling systems will be described, in detail, with reference to the following drawings, in which:

FIGS. 1A and 1B illustrate an example correspondence between a visual representation of a three-dimensional coordinate system and a corresponding mathematical representation according to this inventor's previous work as a foundation for the disclosed systems and methods;

FIG. 2 illustrates a block diagram of an exemplary system for implementing a declarative programming scheme to optimize dynamic operations in complex image forming and media handling devices according to this disclosure; and

FIG. 3 illustrates a flowchart of an exemplary method for implementing a declarative programming scheme to optimize dynamic operations in complex image forming and media handling systems according to this disclosure.

### DETAILED DESCRIPTION OF THE DISCLOSED EMBODIMENTS

The systems and methods for implementing declarative programming to optimize dynamic operations in complex image forming and media handling devices according to this disclosure will generally refer to this specific combination of utilities or functions for those systems and methods. Exemplary embodiments described and depicted in this disclosure should not be interpreted as being specifically limited to any particular configuration, any particular set of mathematical representations associated with a set of coordinate spaces, or any particular programming language, or as being specifically directed to any particular intended use. Any methodology for controlling complex operations in which components are subjected to a flow of the individual components through a complex manufacturing system including multiple devices each including its own flow path for the individual components through a particular device that may orient the components in three dimensions is contemplated as being included in this disclosure.

Specific reference to, for example, an image forming device throughout this disclosure should not be considered as being limited to any particular type of image forming device including, for example, any of a printer, a copier or a multi-function device. The terms “image forming device” and “complex image forming device,” as referenced throughout this disclosure are intended to refer globally to any component, device, system, or system of systems that include various capabilities for electronic image processing and/or image receiving media handling. These various capabilities generally include receiving an image from an image source and an image receiving medium from an image receiving medium source, registering the image on the image receiving medium, and finishing the image forming process by mechanically manipulating the image receiving medium with some manner of finisher. The finisher may comprise, for example, a stapling device, a folding device, a binding device, or other like output finishing device that would be familiar to those of skill in the art.

The systems and methods according to this disclosure will be described as being particularly adaptable to use in complex image forming systems including a plurality of feeder and finisher devices, but the systems and methods according to this disclosure should not be considered as being limited to any particular level of complexity or any particular combination of image processing and/or media handling component devices.

The systems and methods according to this disclosure make particularly advantageous use of the concept of declarative programming. Declarative programming is generally understood to describe computational functions by specifying what a program should do rather than specifying how the program should do it. In declarative programming, certain characteristics of a problem in the form of defined input conditions and the desired output conditions are specified in a particular programming language. The declarative programming scheme then leaves it to the computer executing (or running) the program to determine a best approach by which to solve the problem based on particular constraints.

In literature, declarative programming has been characterized as setting forth, in its programming architecture, theories defining a formal logic space, i.e., an input logic state and an output logic state that bound the formal logic space. The computations undertaken by the computer then executing the declarative programming scheme are akin to a series of deductions undertaken in the defined formal logic space to get from the input logic state to the output logic state. Users, such as programmers, concentrate on specifically defining the input logic state and the output logic state rather than the series of program steps required in a procedural programming language to convert the input state to the output logic state. Declarative programming describes “what” computations should be performed and not “how” to perform the computations. Declarative programming languages are often recognized as having a clear correspondence to mathematical functions.

In the context of a complex image forming system, consider a situation where a raster image processor (RIP) may take a source image and convert it to a raster image in a particular orientation. The raster image may require a rotation before being placed on an image receiving medium because a finisher in the complex image forming system is oriented 180 degrees out from standard for some appropriate reason. Additionally, the image receiving medium may be in the form of a pre-printed form. Image receiving media with the form pre-printed thereon may be loaded in an input tray face down, and short edge feed (SEF) according to a prescribed loading for the image receiving media. These are but a few of the variables that may be resident in a complex image forming system. Those of skill in the art recognize that it does not take definition of many of the myriad variables that could be introduced in the complex image forming system to create a combinatoric space of combined operations and orientations in two dimensions and in three dimensions.

To alleviate the burden on the software developer, in his or her struggle to make this situation work, typically by trial and error, the disclosed method takes a known input orientation as an input logic state, and a known desired output orientation as an output logic state. A declarative programming scheme is implemented that determines a best logical approach to link the input logic state with the output logic state. Given, for example, a raster output scanner (ROS) raster orientation and the raster orientation of an image that the user desires to print, the specific orientations may be declared as the input logic state and the output logic state. The intervening automated logic determines feasible and correct orientation operations in two dimensions, typically imaging rotations and reflections, and in three dimensions, e.g., sheet inversion or rotation.

The method may take any pair of two start and end orientation states described in terms of mathematical transformations. The method generates all possible correct operations between those start and end states. The method yields varying sets of operations based on the selection of start and end orientation matrices. These sets of operations can vary in numbers of operations, typically one to three operations for rotations and reflections in three dimensions. Many operations to transform an input orientation to an output orientation may be accomplished in a single step. It is recognized then that many other possible operations may be undertaken that include additional operations. The inclusion of unnecessary operations is generally considered inefficient and undesirable. This may not always be the case however. In image forming devices, for example, it is a common practice to include a pair of reflections to achieve a 180 degree rotation of an image, because two reflection operations may be faster than a full image rotation. This is an example where reflection operations may be differently weighted in the automatic selection and prioritization process undertaken by the method. Further, the method may define multiple concurrent paths as being available alternatives for use, even if less efficient, when a desired or optimal path is otherwise in use, or may need to be bypassed because some malfunction occurs in that path.

In complex systems, it is difficult to visualize the combinations of visual raster devices, for example, in combination with image receiving media flowing through the devices. The declarative programming approach allows for a definition of entering and exiting orientation conditions obviating the requirement to continue to undertake detailed trial and error. This approach has the advantage of avoiding the very time consuming and fragile conventional trial and error scheme to make the complex image forming system function correctly, according to the user's desires.

For any combination of input states and output states, there are large numbers (on the order of multiple thousands) of potentially feasible ordered combinations of operations to convert the input state to the output state. The method may apply the declarative programming to generate these large numbers of potential combinations of operations to convert the input state to the output state in the complex image forming system. The declarative programming will be provided with certain constraints to recognize that certain of the combinations are not feasible. Otherwise, the declarative programming will be provided with additional restrictions by which to frame an appropriate level of efficiency, i.e., in a certain specified number of steps. For example, in view of the brief description above, one to three steps may be considered an appropriate level of efficiency while a five step operation may be considered inefficient and therefore undesirable. A user, for example, may not even understand that three or even more operations may be required for certain transformations from source coordinate space to a target coordinate space.

The declarative program employs the mathematical description of the beginning orientation and the ending orientation and applies combinations of inverses and the concepts of matrix algebra (multiplication) to define the multiple transformations between the orientations. The method may then decompose the transformations between the beginning and ending orientation states to enumerate all of the possible combinations according to, for example, (1) a number of operations, (2) types of operation (rotation and/or reflection in two dimensions and/or three dimensions, and (3) an ordering of operations. It is this combination of variables that generates the large combinatoric space within which the solution is discerned. The method matrix multiplies the possible combinations to determine whether those combinations of operations will result in the desired output state. In many cases, that answer will be “no.” Out of the thousands of permutations then, the method is able to determine which combinations are feasible. As indicated above, ordering of the operations is significant based on the non-commutative properties of combining operations.

Prototype code generates all possible operation sets based on a “declared” source and target pair of orientations that produces a list of feasible operation sets consisting of rotation and reflection operations in three dimensions. A composite of these operations via matrix multiplication applied to a source orientation matrix will produce the desired target orientation matrix for each set in the list of operation sets. All possible permutations may be generated (over 3000) and the list may be limited to determine successful combinations, i.e., operation lists of rotations and reflections that, when composited and applied to the source orientation, give the desired target orientation.

Simply put, the method takes, as input states and output states, specified orthogonal orientations characterized as mathematical representations. The method then generates, according to some user-defined constraints, the multiple sets of operation transformations that will result in the desired output state given the specified input state. In doing so, the method permutes the combinations of operations including specified rotations in a specified direction about a specified axis and reflections across the three axes, as well as the ordering of the operations, to generate the several thousand candidate operation sets. Applying matrix multiplication to the mathematical representations, the method is able to specify a composite transformation according to each combination of operations in a specified order. Each composite transformation is then applied to the input state transformation, i.e., the input state mathematical representation is matrix multiplied by a mathematical representation of the composite transformation to determine whether the output transformation is achieved. This defines “feasibility” of the particular combination of operations in the specified order.

The output of the method may provide a system designer, for example, with an indication that inclusion of the specific device in a specific location in the flow path through the complex image forming system may result in a non-feasible outcome. In other words, if a particular device, with a particular flow path through the device, is inserted into the overall flow path for the complex system, the output state may not be achievable based on the specified input state.

Additionally, performance metrics can be specified for a particular operation. The output of the method can then be sorted based on the performance metrics assigned to the particular operation.

A system designer may then decompose the complex image forming system into individual components and review the input and output conditions for each of the individual components in order to optimize system performance by determining a best mix of the individual components to achieve the required output state based on a specified input state.

The method can be applied for each component device in the complex system, or across an entire flow path for the overall complex system. The system developer may be able to take a look at the set of available devices by which to compose the complex image forming system and determine a specified ordering of those individual devices based on the output from the method in order to achieve the desired output state given a specified input state. If there are, for example, available to the system designer multiple different devices that could be combined multiple different ways, the outputs of the method may aid the system designer in determining a best approach to combining those multiple different devices in a specified order to achieve the desired output state. As components in an installed complex system, therefore, need to be changed, the system designer is advised regarding whether a replacement device may adversely affect the operation flow through the image forming device. Additionally, the system designer may be alerted to some minor modification that could be made, for example, in the imaging software to add a reflection or rotation at a specified point in the order of operations for individual device that may streamline the imaging process through the complex image forming system. Separately, the system designer may be provided with a tool that aids the system designer in determining that a simple change in the input state may aid in streamlining the flow path in order to achieve the desired output state.

In addition to making the feasible paths available, previously-created orientation graphs can be generated to give visual insights into possible paths for either design or diagnostics purposes. For all possible orientations, and all possible pairs of orientations, the range of feasible operation sets is large and difficult to comprehend. Visual tools will help the user to understand what each step is doing as the image processing operation proceeds in the complex image forming system. An objective is to provide image forming devices that describe their orientation possibilities, and for image path and/or image receiving medium path scheduling to be enhanced to automatically create an optimal flow output based on a given configuration of feasible operation sets/paths, which are limited and prioritized based on inputs including those regarding a configuration of the complex image forming system and the individual component devices that comprise the complex image forming device. This capability is an important component in managing the combinatoric complexity via the disclosed system and method. Graphics of the orthogonal orientation matrices may be used to show interim orientation states after each operation is performed. This would provide the user with previously unachievable insight into orientation operations.

Further, for a given configuration, constraints are inherent in the particular imaging or image receiving medium handling devices. This information can be used to constrain the feasible operations. Constraining of the list of operations is simple. It is possible to constrain the operation list used for permutations (e.g., knock out individual operations prior to permutation) or to constrain the generated list. Simply reordering devices may yield desired results, and this can be a feature (e.g., to have a smart system evaluate a current configuration or a database of available/possible devices and suggest reversing a modular sheet rotator and downstream sheet inverter in the paper path or recommend a different configuration altogether).

The method provides a novel approach by categorizing all possible orientations, in two dimensions for imaging operations, and in three dimensions for media handling operations, according to mathematical transformations that can then be manipulated under the known concepts of matrix algebra to automatically determine feasible operations for complex image forming systems. The method describes the given input orientation as an input logic state and the desired output orientation as an output logic state, each being defined according to a mathematical representation and the processor applies matrix algebra to manipulate the input mathematical representation in order to determine feasible, optimized, and possibly constrained operations to achieve the output mathematical representation. This approach abandons the time-consuming and often haphazard conventional approach of describing orientations descriptively, and inconsistently across visual, raster, sheet, and device coordinate systems, and then applying a trial and error method to arrive at a desired output state by manipulating, for example, in a blind manner, an input state or an order of operations in the complex image forming system. The automation shown here is only made possible because of the formalization in describing the orthogonal orientations mathematically.

This mathematical approach to describing orthogonal orientations provides a visual designer with the capacity to display a representation of the orthogonal orientation at any point in the complex image forming system, e.g., after each feasible operation orientation changes state. The orthogonal orientations may be shown using simple known orientation graphics. These tools provide system designers and customers with previously unavailable tools for determining feasible, optimal configurations. These tools may aid in augmenting current scheduling capabilities for operations within complex image forming systems. Further, these tools could be used to prevent infeasible jobs from running in the complex image forming system in a manner that may degrade the operation of the system. Sorting may allow optimal image processing flow paths to be selected to improve concurrent processing as well as to effect graceful redirection in the case of optimal path failure. Weighting factors may provide system designers customers an ability to determine most efficient and cost-effective operations for the complex image forming system.

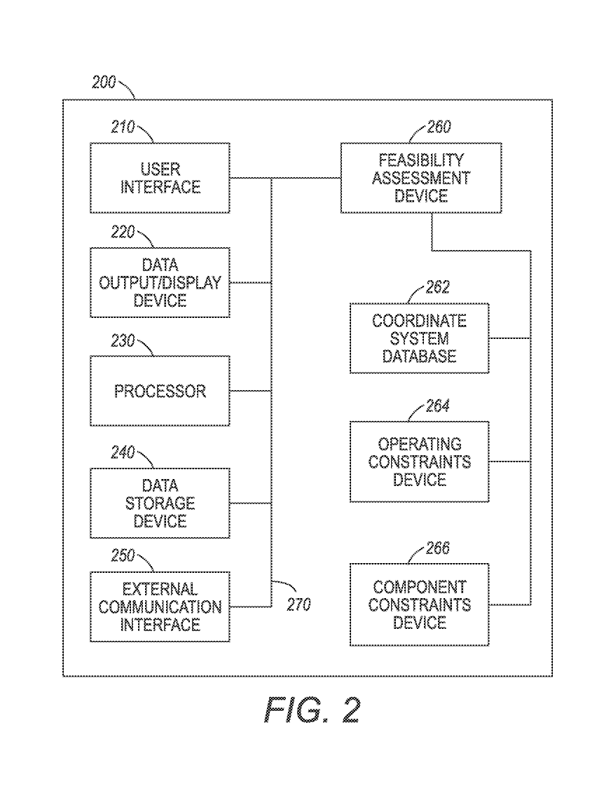

FIG. 2 illustrates a block diagram of an exemplary system 200 for implementing declarative programming to optimize dynamic operations in complex image forming and media handling devices according to this disclosure. Although the exemplary system 200 may receive design inputs, and constraint information, regarding a particular complex image forming device, an embodiment of the exemplary system 200 will be a standalone system apart from any particular image forming device in order to provide prioritized feasibility information on the combinations and the orders of operations through declarative programming schemes that will aid system programmers, designers and customers in understanding individual orientations associated with the operations of complex image forming system.

The exemplary system 200 may include a user interface 210 by which a user may communicate with the exemplary system 200. The user interface 210 may be configured as one or more conventional mechanisms common to computing devices such as, for example, a user's workstation, that permit the user to input information to the exemplary system 200. The user interface 210 may include, for example, a conventional keyboard and mouse, a touchscreen with “soft” buttons or with various components for use with a compatible stylus, a microphone by which a user may provide oral commands to the exemplary system 200 to be “translated” by a voice recognition program, or other like device by which a user may communicate specific operating instructions to the exemplary system 200.

The user interface 210 may be employed by the user to provide instructions to the exemplary system 200 to direct operations of the system 200. The user interface 210 may be employed by the user to define a known input orientation state and a desired output orientation state for one or both of an image and an image receiving medium to be processed by a complex image forming system. A characterization of the input orientation may be according to either a mathematical representation matrix, or by, for example, visually selecting a graphical representation of the known input orientation state and the desired output orientation state as presented on a display device associated with the user interface 210. According to the latter, a user needs to know nothing about matrices making it very simple for the user. The output can also be visually represented. The selection (definition) process can be completely a clickable, visual experience. The user interface 210 may also be employed to allow the user to input constraints on the feasibility of combinations of operations and orders of operations to be carried out by the exemplary system 200. These input constraints may include specification of the total number of operations that are acceptable between the known input orientation state and the desired output orientation state, weighting and/or costing factors regarding individual operations to be assessed by the prioritizing undertaken by the exemplary system 200, and any known device-based constraints on the prioritizing based on, for example, currently-available component devices to make up the complex image forming system.

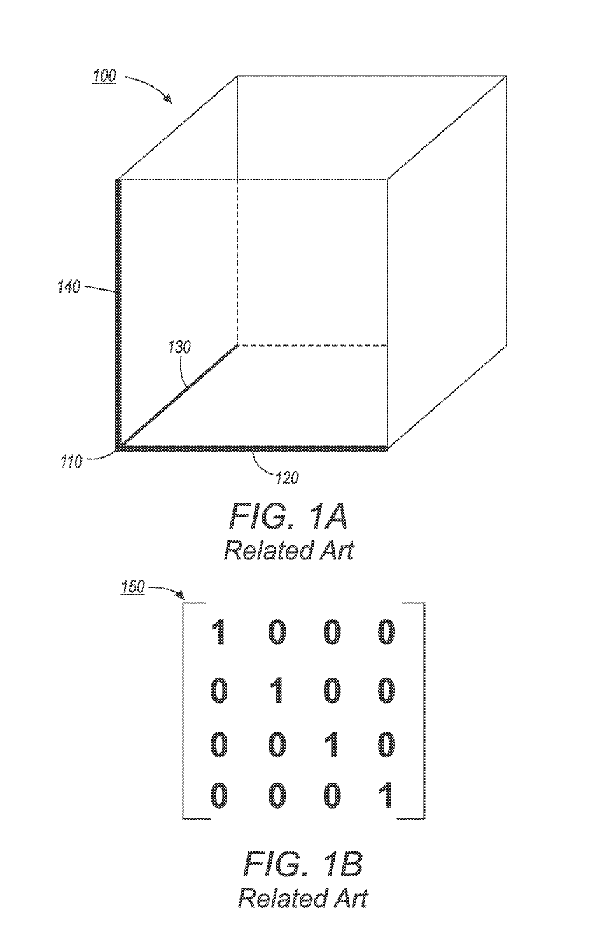

The exemplary system 200 may include a data output/display device 220 that may display information regarding user input provided via the user interface 210, as well as information regarding the functioning of the exemplary system 200. The data output/display device 220 may be, for example, employed to display varying orientations to include the known input orientation state, the desired output orientation state, and intermediate orientations according to a user's desires. When displaying specific orientations, it is anticipated that the data output display device 220 may provide visual graphical depictions of three-dimensional coordinate systems in the manner shown, for example, in FIG. 1A, or otherwise some combination of the visual and associated mathematical representations shown respectively in FIGS. 1A and 1B. In this manner, a user may be easily informed regarding specific orientations under scrutiny with no need to understand the underlying processing. The data output/display device 220 may comprise any conventional means by which to display relevant data regarding the functioning of the exemplary system 200, and may provide the user, in conjunction with the user interface 210, a means to interactively communicate with, and control, the functions undertaken by the exemplary system 200.

The exemplary system 200 may include one or more local processors 230 for individually operating the exemplary system 200 and carrying out the portions of the feasibility assessment and prioritizing functions of the exemplary system 200. Processor(s) 230 may include at least one conventional processor or microprocessor including, for example, a Graphical Processing Unit (GPU) or Central Processing Unit (CPU), that may be provided to interpret and execute instructions in cooperation with other system components for executing a declarative programming scheme based on a known input orientation state that may be received via a user interface 210, or otherwise may be recovered from some digital data storage device, and a desired output orientation state that may be received or recovered in the same manner.

The exemplary system 200 may include one or more data storage devices 240 to store relevant data, and/or such operating programs as may be used by the exemplary system 200, and specifically the processor(s) 230 to carry into effect the specified feasibility assessment and prioritizing of orientations using declarative programming according to this disclosure. At least one data storage device 240 may be designated to act as a specific repository for storing a database that may be pre-loaded with mathematical transformations representing available two-dimensional or three-dimensional orientations for specified combinations and orders of operations. Rather than calculating all of the composite transformations, certain common composite transformations may be stored in the at least one data storage device 240 to be referenced in the feasibility assessing and prioritizing carried out under a declarative programming scheme in the exemplary system 200.

Data storage device(s) 240 may include a random access memory (RAM) or another type of dynamic storage device that is capable of storing collected information, and separately of storing instructions for execution of system operations by, for example, processor(s) 230. Data storage device(s) 240 may also include a read-only memory (ROM), which may include a conventional ROM device or another type of static storage device that stores static information and instructions for processor(s) 230.

The exemplary system 200 may include one or more external data communication interfaces 250. The external data communication interface(s) 250 may be provided to facilitate communication with one or more external devices including, but not limited to, user workstations and/or one or more complex image forming systems in order to obtain from, or provide to, the user workstations or the one or more complex image forming systems, information regarding, for example, constraints on the prioritizing function of the exemplary system 200 that may be automatically obtained from such external devices. The external data communication interface(s) 250 may be provided to facilitate wired or wireless communication between the exemplary system 200 and the one or more external devices.

The exemplary system 200 may include a feasibility assessment device 260 that may be specifically linked to individual system components such as, for example, a coordinate system database 262, whether resident in at least one of the data storage devices 240, or otherwise provided separately; an operating constraints device 264, which may be used to place limitations on the prioritizing function carried out by the exemplary system 200; and a component constraints device 266, which may include a database of, for example, known device components to be included in a complex image forming system and the specific sets of operations and orders of operations to which those known device components may be constrained. The feasibility assessment device 260 may operate in conjunction with the processor(s) 230 and/or the one or more storage devices 240 to undertake a review of feasible combinations of operations, and orders of operations, to convert a known input orientation state to a desired output orientation state using a declarative programming scheme as discussed in this disclosure. As depicted, it is anticipated that, where separate devices aid in the feasibility assessment, those devices will communicate only with the feasibility assessment portions of the exemplary system 200.

All of the various components of the exemplary system 200, as depicted in FIG. 2, may be connected by one or more data/control busses 270. These data/control busses 270 may provide wired or wireless communication between the various components of the exemplary system 200 regardless of whether those components are housed within, for example, a single computing device, or individual ones of the components are housed independently.

It should be appreciated that, although depicted in FIG. 2 as what appears to be an integral unit, the various disclosed elements of the exemplary system 200 may be arranged in any combination of sub-systems as individual components or combinations of components, integral to a single unit, or as separate components housed in one or more user workstations, associated with one or more image forming devices, or may be otherwise remotely located. Therefore, no specific configuration for the exemplary system 200 is to be implied by the depiction in FIG. 2.

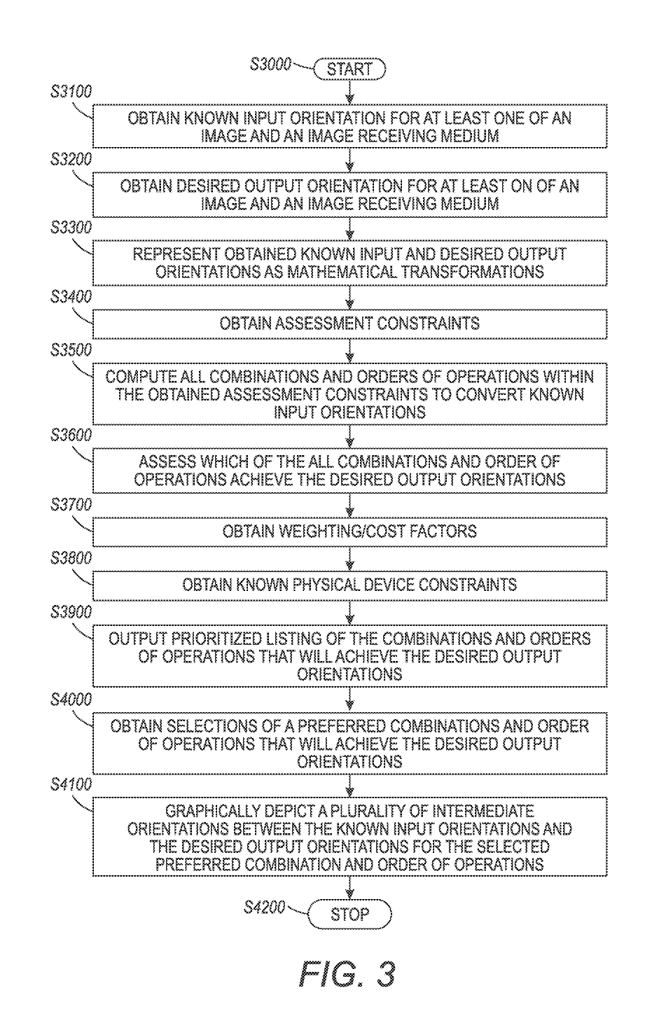

The disclosed embodiments include a method for implementing a declarative programming scheme to optimize dynamic operations in complex image forming and media handling systems. FIG. 3 illustrates a flowchart of such an exemplary method. As shown in FIG. 3, operation of the method commences at Step S3000 and proceeds to Step S3100.

In Step S3100, a known input orientation for at least one of an image and an image receiving medium may be obtained. The known input orientation will be described according to a specific two-dimensional or three-dimensional coordinate system. The known input orientation may be obtained as one input to a declarative programming scheme. The known input orientation may be obtained manually via, for example, a manual user input, or may otherwise be obtained automatically in communication with at least one image forming device, or, for example, retrieved from a stored database that includes information regarding known input orientations for a set of image forming devices. Operation of the method proceeds to Step S3200.

In Step S3200, a desired output orientation for at least one of an image and an image receiving medium may be obtained. The desired output orientation will also be described according to a specific two-dimensional or three-dimensional coordinate system. It is anticipated that the specific two-dimensional or three-dimensional coordinate system that describes the desired output orientation will be different from the two-dimensional or three-dimensional coordinate system that defines the known input orientation. The desired output orientation may be obtained in any manner similar to that by which the known input orientation may be obtained, as described above. Operation of the method proceeds to Step S3300.

In Step S3300, each of the obtained known input orientation(s) and desired output orientation(s) may be represented as a mathematical representation as a matrix. Representation of each of the orientations as a mathematical representation matrix provides for common interpretation of the orientations in a two-dimensional or three-dimensional coordinate system that is device agnostic. Such representation, in addition to providing common interpretation for the orientations, yields a format that can be manipulated according to known matrix algebra principles. Operation of the method proceeds to Step S3400.

In Step S3400, any constraints that are to be applied to the combinations of operations and orders of operations to be assessed by the feasibility assessment may be obtained. Those of skill in the art recognize that an unconstrained assessment of complex transformations that can be applied to the known input orientation would yield an infinite number of possible combinations and orders of operations. The constraints to be obtained in Step S3400 may be as simple as specifying a maximum number of operations. As was discussed above, it is not anticipated that the method will be constrained to assessing the feasibility of, for example, only single operations in an instance where a single operation may suffice. Without constraint, however, many redundant and grossly inefficient large numbers of combinations of operations and permuted orders of operations may be returned by the declarative programming scheme. Operation of the method proceeds to Step S3500.

In Step S3500, all known combinations of operations, given the assessment constraints set forth in Step S3400, may be computed. In each instance, it is anticipated that the declarative programming scheme will return a plurality of complex transformation matrices representing specific combinations of operations and orders for those operations based on a matrix multiplication of mathematical representations of the specific combination of operations and order of those operations. Operation of the method proceeds to Step S3600.

In Step S3600, an assessment is undertaken as to which of the returned set of all of the combinations of operations and orders of operations represented by the complex transformation matrices may be feasible. The feasibility assessment may take the mathematical representation of the known input orientation and matrix multiply that mathematical representation by the complex transformation matrix that mathematically represents each of the combinations of operations and orders of operations to determine which of the matrix multiplication functions result in a mathematical representation of the desired output orientation. At this point, the method may output a determined (or “pruned”) list of each of the feasible combinations of operations and orders of operations that convert the known input orientation to the desired output orientation. Operation of the method proceeds to Step S3700.

In Step S3700, weighting and/or costing factors for any individual operations, combinations of operations, or orders of operations may be obtained. Operation of the method proceeds to Step S3800.

In Step S3800, in instances where a particular image forming device, media handling device, or combination sub-system may be under consideration for use in, or may be a required component of, a complex image forming system design, and because a combination of operations and order of operations in a particular image forming device may be specified, and unchangeable, any constraints based on inclusion of the particular image forming device in the overall combination of operations and/or order of operations may be obtained. Operation of the method proceeds to Step S3900.

In Step S3900, any of the factors or constraints obtained in Steps S3700 and S3800 may be applied to the determined list of each of the feasible combinations of operations and orders of operations obtained in Step S3600 in order that a prioritized list of the combinations of operations and orders of operations that will achieve the desired output orientation state, given the known input orientation state, may be produced and output. As discussed in detail above, this prioritized list may be used by system designers, programmers and users of complex image forming systems to facilitate understanding of orientations occurring within a particular combination of operations and/or order of operations. Operation of the method proceeds to Step S4000.

In Step S4000, one or more preferred combinations and/or orders of operations that will achieve the desired output orientation may be selected from either of an output produced in Step S3600 or in Step S3900. Operation of the method proceeds to Step S4100.

In Step S4100, one or more of the intermediate mathematical representations of the one or more preferred combinations and/or orders of operations selected in Step S4000 may be extracted and converted into a visual graphical depiction of the two-dimensional or three-dimensional coordinate space characterized by the intermediate mathematical representation and the visual graphical depiction of the two-dimensional or three-dimensional coordinate space may be displayed to a user. Operation the method proceeds to Step S4200, where operation the method ceases.

The disclosed embodiments may include a non-transitory computer-readable medium storing instructions which, when executed by a processor, may cause the processor to execute all, or at least some, of the steps of the method outlined above.

The above-described exemplary systems and methods reference certain conventional components to provide a brief, general description of suitable processing means by which to carry into effect the disclosed feasibility and priority assessments for familiarity and ease of understanding. Although not required, elements of the disclosed exemplary embodiments may be provided, at least in part, in a form of hardware circuits, firmware, or software computer-executable instructions to carry out the specific functions described. These may include individual program modules executed by one or more processors. Generally, program modules include routine programs, objects, components, data structures, and the like that perform particular tasks, or implement particular data types, in support of the overall objective of the systems and methods according to this disclosure.

Those skilled in the art will appreciate that other embodiments of the disclosed subject matter may be practiced with many types of computing systems in many different configurations, executing computer programs in various languages. The systems and methods according to this disclosure are particularly adaptable to declarative programming schemes. It should be recognized that embodiments according to this disclosure may be practiced, for example, in computing systems executing differing programming languages, embodiments according to this disclosure may be practiced in network environments, where processing and control tasks may be performed according to instructions input at a user's workstation and/or according to predetermined schemes that may be stored in data storage devices and executed by particular processors, which may or may not be in communication with, one or more image forming devices or complex image forming systems.

As indicated above, embodiments within the scope of this disclosure may also include computer-readable media having stored computer-executable instructions or data structures that can be accessed, read and executed by one or more processors. Such computer-readable media can be any available media that can be accessed by a processor, general purpose or special purpose computer. By way of example, and not limitation, such computer-readable media can comprise RAM, ROM, EEPROM, CD-ROM, flash drives, data memory cards or other analog or digital data storage device that can be used to carry or store desired program elements or steps in the form of accessible computer-executable instructions or data structures. When information is transferred or provided over a network or via another communications connection, whether wired, wireless, or in some combination of the two, the receiving processor properly views the connection as a computer-readable medium. Combinations of the above should also be included within the scope of the computer-readable media for the purposes of this disclosure.

Computer-executable instructions include, for example, non-transitory instructions and data that can be executed and accessed respectively to cause a processor to perform certain of the above-specified functions, individually or in various combinations. Computer-executable instructions may also include program modules that are remotely stored for access and execution by a processor.

The exemplary depicted sequence of executable instructions or associated data structures represents one example of a corresponding sequence of acts for implementing the functions described in the steps. The exemplary depicted steps may be executed in any reasonable order to effect the objectives of the disclosed embodiments. No particular order to the disclosed steps of the method is necessarily implied by the depiction in FIG. 3, and the accompanying description, except where a particular method step is a necessary precondition to execution of any other method step.

Although the above description may contain specific details, they should not be construed as limiting the claims in any way. Other configurations of the described embodiments of the disclosed systems and methods are part of the scope of this disclosure.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A method for assessing flow paths in an image forming system, comprising:
obtaining an input orientation state for at least one of an image and an image receiving medium associated with the image forming system, the image forming system combining image processing operations and media handling operations;
obtaining an output orientation state for at least one of an image an image receiving medium associated with the image forming system;
describing each of the input orientation state and the output orientation state respectively according to a first mathematical representation and a second mathematical representation;
determining, with a processor, a plurality of combinations of the image forming operations and the media handling operations for the image forming system;
representing each of the plurality of combinations of the image forming operations and the media handling operations as a complex mathematical representation;
determining feasible combinations of the image forming operations and the media handling operations by matrix multiplying the first mathematical representation by each complex mathematical representation, the feasible combinations being a set of matrix multiplications a product of which is the second mathematical representation; and
outputting a list of the determined feasible combinations.

2. The method of claim 1, the plurality of combinations of the image forming operations in the media handling operations for the image forming system including an order of at least one of the image forming operations and the media handling operations.

3. The method of claim 1, the processor being programmed to determine the plurality of the combinations of the image forming operations and the media handling operations using a declarative programming scheme.

4. The method of claim 1, each of the input orientation state and the output orientation state representing a respective first and second three-dimensional coordinate system, the first mathematical representation and the second mathematical representation mathematically describing the respective first and second three-dimensional coordinate system in a mathematical matrix format.

5. The method of claim 1, the processor being programmed to determine the plurality of the combinations of the image forming operations and the media handling operations based on a prescribed set of assessment constraints.

6. The method of claim 5, the prescribed set of assessment constraints being stored in an image storing device for recovery by the processor.

7. The method of claim 5, the prescribed set of assessment constraints being received via a user interface from a user.

8. The method of claim 5, the prescribed set of assessment constraints including at least a maximum number of operations to be considered.

9. The method of claim 1, further comprising:
applying at least one of a weighting factor or a costing factor to at least one of the image forming operations or the media handling operations;
sorting the determined feasible combinations according to the applied at least one of the weighting factor or the costing factor; and
outputting a prioritized list of the sorted determined feasible combinations.

10. The method of claim 9, the at least one of the weighting factor or the costing factor being stored in an image storing device for recovery by the processor.

11. The method of claim 9, the at least one of the weighting factor or the costing factor being received via a user interface from a user.

12. The method of claim 1, further comprising:
applying at least one known system constraint based on inclusion of a particular device having a defined combination and order of image forming and media handling operations; and
outputting a modified list of the determined feasible combinations based on the at least one known system constraint.

13. The method of claim 1, further comprising:
selecting one of the determined feasible combinations of the image forming operations and the media handling operations;
decomposing the selected one of the determined feasible combinations of the image forming operations and the media handling operations into an ordered set of sequential individual image forming operations and media handling operations; and
extracting a mathematical representation for at least one intermediate orientation in the ordered set of sequential individual image forming operations and media handling operations.

14. The method of claim 13, further comprising:
converting the extracted mathematical representation for the at least one intermediate orientation into a visual graphical depiction of the at least one intermediate orientation; and
displaying the visual graphical depiction of the at least one intermediate orientation to a user.

15. The method of claim 14, further comprising receiving a user input regarding the at least one intermediate orientation in the ordered set of sequential individual image forming operations and media handling operations to be displayed in the visual graphical depiction to the user.

16. A system for assessing flow paths in an image forming system, comprising:
an input device that provides an input orientation state and an output orientation state for at least one of an image and an image receiving medium associated with the image forming system, the image forming system combining image processing operations and media handling operations;
a processor that is programed to:
describe each of the input orientation state and the output orientation state respectively according to a first mathematical representation and a second mathematical representation;
determine a plurality of combinations of the image forming operations and the media handling operations for the image forming system; and
represent each of the plurality of combinations of the image forming operations and the media handling operations as a complex mathematical representation;
a feasibility assessment device that determines feasible combinations of the image forming operations and the media handling operations by matrix multiplying the first mathematical representation by each complex mathematical representation, the feasible combinations being a set of matrix multiplications a product of which is the second mathematical representation; and
an output device that outputs a list of the determined feasible combinations.

17. The system of claim 16, the processor being further programmed to determine the plurality of the combinations of the image forming operations and the media handling operations using a declarative programming scheme.

18. The system of claim 16, the processor being further programmed to limit the plurality of the combinations of the image forming operations and the media handling operations based on at least one of (1) a prescribed set of assessment constraints, (2) at least one of a weighting factor or a costing factor for at least one of the image forming operations or the media handling operations, and (3) at least one known system constraint based on inclusion of a particular device having a defined combination and order of image forming and media handling operations.

19. The system of claim 16, further comprising a display device that displays a visual graphical depiction of at least one intermediate orientation to a user,
the at least one intermediate orientation being selected by the user from an ordered set of sequential individual image forming operations and media handling operations in one of the determined feasible combinations.

20. A non-transitory computer-readable medium storing instructions which, when executed by a processor, cause the processor to execute the steps of a method comprising:
obtaining an input orientation state for at least one of an image and an image receiving medium associated with an image forming system, the image forming system combining image processing operations and media handling operations;
obtaining an output orientation state for at least one of an image and an image receiving medium associated with the image forming system;
describing each of the input orientation state and the output orientation state respectively according to a first mathematical representation and a second mathematical representation;
determining a plurality of combinations of the image forming operations and the media handling operations for the image forming system;
representing each of the plurality of combinations of the image forming operations and the media handling operations as a complex mathematical representation;
determining feasible combinations of the image forming operations and the media handling operations by matrix multiplying the first mathematical representation by each complex mathematical representation, the feasible combinations being a set of matrix multiplications a product of which is the second mathematical representation; and
outputting a list of the determined feasible combinations.
